(19) United States
(12) Patent Application Publication
(10) Pub. No.: US 2022/0405787 A1
(43) Pub. Date: Dec. 22, 2022

(54) DEMAND NOTIFICATION DEVICE, COMPUTING DEVICE AND DEMAND NOTIFICATION METHOD

(71) Applicant: GRABTAXI HOLDING PTE. LTD., Singapore (SG)

(72) Inventors: Xueou WANG, Singapore (SG); Bryan Kuen-Yew HOOI, Singapore (SG); Renrong WENG, Singapore (SG); Pravin Vinodkumar KAKAR, Singapore (SG); See Kiong NG, Singapore (SG); Wynne HSU, Singapore (SG)

(21) Appl. No.: 17/619,671

(22) PCT Filed: Mar. 6, 2020
(86) PCT No.: PCT/SG2020/050112

§ 371 Date: Dec. 16, 2021

(51) Int. Cl. G06Q 30/02; G06Q 50/30; G06Q 50/28

(52) U.S. Cl. CPC G06Q 30/0205; G06Q 50/30; G06Q 50/28

(57) ABSTRACT

Aspects concern a demand notification device (110), comprising: a determining unit (122) configured to determine a quantity of a demand of a transport service for a plurality of users (102, 104, 106) having a predetermined area as destination in a first time period, the quantity of the demand indicating how many users of the plurality of users are determined to desire to travel into the predetermined area; and wherein the determining unit (122) is further configured to determine a real space service demand from a plurality of users (102, 104, 106) to be fulfilled in the predetermined area in a second time period, wherein the real space service is provided by a service provider (120); an analysis unit (124) configured to determine a predicted real space service demand in a third time period for the predetermined area based on the quantity of users (102, 104, 106) in the predetermined area at the first time period and the demand of real space service in the predetermined area in the second time period and further configured to monitor the predicted real space service demand in the third time period in the predetermined area regarding a threshold value of service demand for the predetermined area at the third time; and a notification unit (126) configured to submit a notification to the real space service provider (120) in case the predicted real space service demand is beyond the threshold value.

### TECHNICAL FIELD

Various aspects of this disclosure relate to data processing systems related to a demand notification.

### BACKGROUND

Knowing your customers, looking for new potential customers and providing personalized services are essential tasks of business. It is often cost-heavy to conduct large-scale market research to achieve such goals. With the prosperity of location-based services, transportation network companies are exploring new techniques to understand customers via spatio-temporal data mining. This can be helpful in developing business strategies when such companies start to enter new business field, for example, food delivery service.

In the related art, a collaborative filtering framework built in deep learning architecture is used to learn non-linear relation among data via neural network structure instead of learning through inner product on latent features. However, this approach is based on a traditional user-item single domain recommender system.

Further, a cross-domain recommendation learning demand notification method may be used. However, the model fit is used in a deep transfer learning neural network to improve target domain recommendation by jointly learning cross-domain knowledge and interactions. The approach is focused on traditional recommender system, making recommendation across domains like news and apps and the embedding of item cross domains are considered separately.

Further, it is known to generate a heat map based on trajectory data to display traffic congestions for generating traffic heat maps for informative information to traffic analytics. We performed cross-domain prediction to predict personalized demand for passengers by deep transfer learning.

Further, it is known to use a distribution model that describes user trajectory graph to reveal a user's behavioral mobility pattern with spatio-temporal data. A user's time and location preference can be detected with feature values. However, this approach is focused more on the moving trajectories of a user analyzing personas and locations in clusters, where similar clusters can have similar feature values, and different clusters can have different ones.

### SUMMARY

Various embodiments concern a demand notification device, a computing device and an allocation demand notification method.

In one aspect of the disclosure, a demand notification device is provided. The demand notification device includes a determining unit configured to determine a quantity of a demand of a transport service for a plurality of users having a predetermined area as destination in a first time period. The quantity of the demand indicates how many users of the plurality of users are determined to desire to travel into the predetermined area. The determining unit is further configured to determine a real space service demand from a plurality of users to be fulfilled in the predetermined area in a second time period. The real space service is provided by a service provider. The demand notification device further includes an analysis unit configured to determine a predicted real space service demand in a third time period for the predetermined area based on the quantity of users in the predetermined area at the first time period and the demand of real space service in the predetermined area in the second time period and further configured to monitor the predicted real space service demand in the third time period in the predetermined area regarding a threshold value of service demand for the predetermined area at the third time. The demand notification device further includes a notification unit configured to submit a notification to the real space service provider in case the predicted real space service demand is beyond the threshold value.

In another aspect, a computing device is provided. The computing device includes one or more processors, and a memory having instructions stored therein. The instructions, when executed by the one or more processors, cause the one or more processors to: determine a quantity of a demand of a transport service for a plurality of users having a predetermined area as destination in a first time period, the quantity of the demand indicating how many users of the plurality of users are determined to desire to travel into the predetermined area, wherein each of the personalized destinations is located within the predetermined area, determine a real space service demand from a plurality of users to be fulfilled in the predetermined area in a second time period, wherein the real space service is provided by a service provider, determine a predicted real space service demand in a third time period in the predetermined area based on the quantity of users in the predetermined area at the first time period and the demand of real space service in the predetermined area in the second time period, monitor the predicted real space service demand in the third time period in the predetermined area to determine whether a threshold value of service demand for the predetermined area at the third time is reached, and submit a notification to the real space service provider in case the predicted real space service demand is beyond the threshold value. Alternatively or in addition, the predetermined area may be flagged for the third time period in the memory.

In another aspect, a demand notification method is provided. The demand notification method including: determine a quantity of a demand of a transport service for a plurality of users having a predetermined area as destination in a first time period, the quantity of the demand indicating how many users of the plurality of users are determined to desire to travel into the predetermined area, determine a real space service demand from a plurality of users to be fulfilled in the predetermined area in a second time period, wherein the real space service is provided by a service provider, determine a predicted real space service demand in a third time period in the predetermined area based on the quantity of users in the predetermined area in the first time period and the demand of real space service in the predetermined area in the second time period, monitor the predicted real space service demand in the third time period in the predetermined area regarding a threshold value for the predetermined area at the third time, and submit a notification to the real space service provider in case the predicted real space service demand is beyond the threshold value.

In the aspects, the notification may be configured to amend a communication schedule and/or a resource plan of the real space service provider. As example, the notification may cause or trigger a reorganization of resources of the service provider. This way, a data rate, a data amount, an amount of communications, a communication density and/or a resource demand of the service provider may be reduced during the third time period. As example, a part of the resource demand may be provided prior to the third time period by the service provider. This way, negative synergetic (non-linear) effects of an increased resource demand may be omitted.

In other words, the subject matter allows a prediction about personalized food delivery demand for any user based on his/her transportation data. Specifically, when, where and how many times will a customer order food through an app given his/her transportation data. This problem is a hybrid of several learning tasks: cross-domain transfer learning, spatio-temporal modeling and a recommender system. Latent and common features between people's travelling habits and food delivery requests is used to provide to understand customers. Embedding learning between transportation and food is shared to make it easier to share information across domains. Common features among related but different domains are used by employing a joint learning model. A personalized demand prediction problem is used in a framework of deep transfer learning recommender system. Users are considered individually and latent embeddings for each user and feature item is constructed.

Illustratively, transportation data from transportation network companies may be used for other business field (real space service), for example, food delivery service. This way, a better understanding about the customers of the other business field is provided. Thus, a temporally aware cross-industry (TAXI) learning process is provided, which jointly learns user/passenger transportation habits and food ordering patterns. The learning process may be constructed in a recommender system framework with deep transfer learning technique. Spatial and temporal features are extracted from raw data and, embeddings for users/passengers and features through a shared weights layer are learned to generate information shared across industries, e.g. data of personalized transport and another real space service, e.g. food delivery. These embeddings are passed through two or more TAXI layers to further learn interaction and nonlinearity among across spatial-temporal features. Thus, extraction and deep transfer learning algorithms for cross-domain (cross-business field) prediction and business marketing is provided, especially when relevant information to the target domain (real space service) is scarce. Illustratively, a temporally aware learning process to make prediction in a domain of severe data insufficiency (predicted real space service demand) is provided by making use of information from another relevant domain (transport data). Then, a prediction problem is provided as a recommender system problem to predict the real space service demand in the predetermined area in the third time period. Thus, common latent temporal and spatial features for spatio-temporal data are provided, wherein temporal-spatial prediction for food orders is correlated with transportation data. This way, better prediction results are achieved, especially for sparse data.

The first, second and/or third time period may be a continuous time period, e.g. one hour.

A real space service is a service fulfilled in real space. Thus, a real space service is not meant to be a pure communication service, as example. However, the real space service demand may be generated over a network. As example, a real space service may be a delivery service of a commodity, e.g. a food delivery service or (express) courier service, wherein the order for the real space service is generated and received by (mobile) communication devices.

In addition, a plurality of predetermined areas may be scored by the devices and the method described above. In other words, the predicted real space service demand may be determined for each of a plurality of predetermined areas. In case resources for fulfilling real space service orders are limited and have to be distributed or organized to fulfill the real space service demand within a predetermined service time, the predetermined areas may be scored/prioritized/weighted to increase the fulfillment rate of real space service. This way, a data traffic between the service provider and the ordering customer and/or subcontractors used to fulfill the real space service order may be reduced, e.g. because exchanged communications may be reduced due to an improved data organization and/or organization of subcontractors, e.g. delivery drivers.

Depending on the threshold value and a predicted real space service demand of the plurality of predetermined areas, the real space service demand may be regulated over the course of a time, as example. As example, the quantity of real space service demand may be reduced or maintained regarding a predetermined value over the time. This way, as example, delivery drivers used for fulfilling the real space service orders may be positioned prior to the third time period in favorable locations regarding the predetermined area in case an increased service demand is predicted in the third time period in a predetermined area. This way the amount of data to be processed is reduced since delivery drivers do not have to be organized, commissioned (e.g. the quantity of required delivery drivers) or repositioned on short notice compared to a scenario in which an unexpected high real space service demand suddenly occurs and has to be handled by the delivery service provider organizing the tour and commission of each of the delivery drivers. This way, memory organization and network efficiency of the delivery service provider is increased. In addition, experience of customers of the real space service demand is increased. Thus, the prediction of a (future) real space service demand reduces peak height in data communications. In other words, the prediction of a (future) real space service demand may decrease a communication demand compared to a scenario in which no prediction of service demand is given.

Further, by the prediction of a (future) real space service demand, as example, delivery drivers as real space service may receive delivery orders from the delivery service provider that lead the delivery driver towards the predetermined area in the third time period. This way, the amount of data that otherwise would have to be processed by (mobile) communication devices of the delivery service provider and delivery drivers is reduced.

### BRIEF DESCRIPTION OF THE DRAWINGS

The invention will be better understood with reference to the detailed description when considered in conjunction with the non-limiting examples and the accompanying drawings, in which:

FIG. 1 shows a demand notification device and computing device according to various embodiments;

FIG. 2 and FIG. 3 show logic flow diagrams of a temporally aware cross-industry learning process; and

FIG. 4 shows a process diagram of a demand notification method according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the enclosure assemblies, vehicles, or demand notification methods are analogously valid for the other enclosure assemblies, vehicles, or demand notification methods. Similarly, embodiments described in the context of an enclosure assembly are analogously valid for a vehicle or a demand notification method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

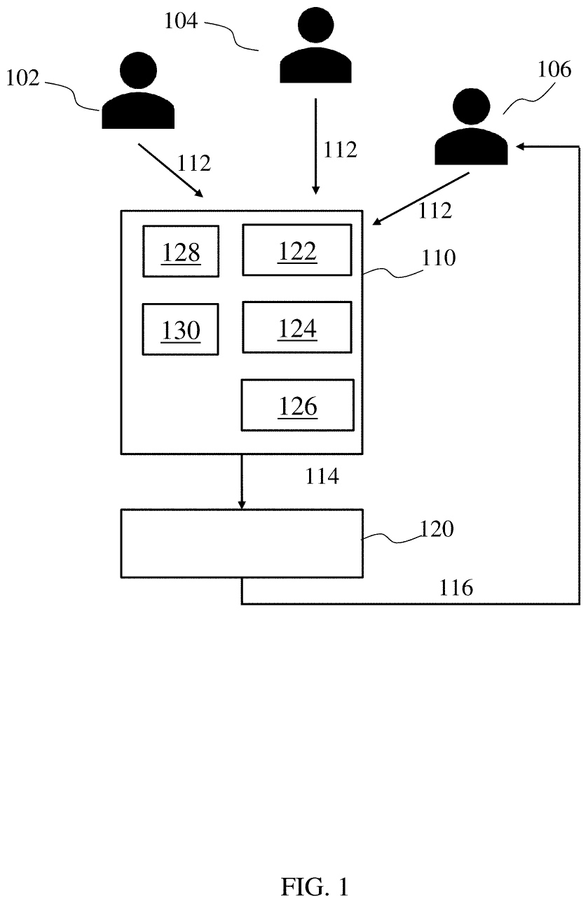

FIG. 1 illustrated a demand notification device 110 (also denoted as computing device 110) according to various embodiments. The demand notification device 110 includes a determining unit 122, an analysis unit 124, a notification unit 126, one or more processors 128 and a memory 130. Illustratively, a quantity of user (also denoted as passenger) uses a personal transportation service, e.g. Grab company. The location of the users in the second time period is recognizable as destination of the transport service in a predetermined area in the first time period.

The predetermined area may include different destinations of users. The predetermined area may be a continuous area, e.g. an office complex, an industry zone, a business district, a residential area, etc. Alternatively or in addition, the predetermined area may have or be a single geohash code area, a single postal code area or a single radio cell area but is not necessarily limited thereto.

The users (passengers) 102, 104, 106 represent a quantity of a plurality of users (customers) in the predetermined area submitting service orders 112 to a service provider 120 offering a service 116 that is to be fulfilled in real space 116, e.g. a food delivery service. In other words, the users of the transport service may be a representative sample of customers using the real space service.

The service order may include a delivery order, e.g. a delivery of a commodity from a first location, e.g. a restaurant providing food, to a second location, e.g. a working place or home of the customer within the predetermined area.

The demand notification device 110 is configured to predict the service demand (amount of service 116) in the predetermined area, e.g. transportation demand having the predetermined area as destination of the transportation service, in a predetermined time (third time period) based on the transportation data in a first time period, as described in more detail below. The demand in real space service in the third time may be determined based on the demand of real space service in a second time period (e.g. same time on the day before or same time of the same week day in the week before) and the sample of users in the first time period. This way, the service provider 120 may plan resources (e.g. parallel communication connections) accordingly and, thus, avoids or reduces a data and/or communication traffic and communication traffic density compared to a case where no predicted service demand is available.

The determining unit 122 may be configured to determine a quantity of users 102, 104, 106 having a demand of transportation service having a destination in a predetermined area in a first time period based. Thus, the transportation demand may be considered on personalized destinations of the users 102, 104, 106 using a transport service (transport data), wherein each of the personalized destinations may be located within the predetermined area.

The determining unit 122 may be further configured to determine a real space service demand (service data) from a plurality of users 102, 104, 106 to be fulfilled in the predetermined area in a second time period. The real space service may be provided by a service provider 120. Some users of the quantity of users 102, 104, 106 using the transport service may be part of the plurality of users requesting the real space service, e.g. a food delivery service or an express postal courier service. However, the quantity of users 102, 104, 106 using the transport service do not have to be necessarily part of the plurality of users requesting the real space service. The quantity of users 102, 104, 106 using the transport service may represent a sample of users in the predetermined area and, thus, represent a correlation or may be proportional to a correlation coefficient between the transport service and the real space service. The determining unit 122 may be a (mobile) communication device, e.g. hosted by the service provider. The determining unit 122 may include a receiver configured to receive real space service orders from users 102, 104, 106.

The analysis unit 124 may be configured to determine a predicted real space service demand in a third time period for the predetermined area based on the quantity of users 102, 104, 106 in the predetermined area at the first time period and the demand of real space service in the predetermined area in the second time period and may be further configured to monitor the predicted real space service demand in the third time period in the predetermined area regarding a threshold value of service demand for the predetermined area at the third time. The analysis unit 124 is communicatively coupled to the determining unit 122 and may receive raw data, e.g. transport data and service orders, from the determining unit 122.

The notification unit 126 may be configured to submit a notification 114 to the real space service provider 120 in case the predicted real space service demand may be beyond the threshold value. Alternatively or in addition, the notification unit may flag or notice the predicted demand in the predetermined area in the third time period in the memory 130. The notification unit 126 is communicatively coupled to the analysis unit 124 and may receive signal data, e.g. predicted service demand, flag signals in case a threshold value of predicted service demand is reached, from the analysis unit 124. The signal data may be transmitted via a transmitter over a network to the service provider and/or stored in a memory, e.g. hosted by the service provider. The notification 114 may be configured to amend a communication schedule and/or a resource plan of the service provider 120. As example, the notification 114 may cause or trigger a reorganization of resources of the service provider. This way, a data rate, a data amount, an amount of communications, a communication density and/or a resource demand of the service provider may be reduced during the third time period.

The memory 130 may have instructions stored therein, the instructions, when executed by the one or more processors 128, cause the one or more processors 128 to: determine a quantity of users 102, 104, 106 in a predetermined area in a first time period based on personalized destinations of the users 102, 104, 106 using a transport service, wherein each of the personalized destinations may be located within the predetermined area; determine a real space service demand from a plurality of users 102, 104, 106 to be fulfilled in the predetermined area in a second time period, wherein the real space service may be provided by a service provider 120; determine a predicted real space service demand in a third time period in the predetermined area based on the quantity of users 102, 104, 106 in the predetermined area at the first time period and the demand of real space service in the predetermined area in the second time period; monitor the predicted real space service demand in the third time period in the predetermined area to determine whether a threshold value of service demand for the predetermined area at the third time may be reached; and submit a notification to the real space service provider 120 in case the predicted real space service demand may be beyond the threshold value. Alternatively or in addition the predetermined area may be flagged for the third time period in the memory 130.

The determination of the predicted real space service demand may be based on a recommender system using the quantity of users 102, 104, 106 in the predetermined area at the first time period and the demand of real space service in the predetermined area in the second time period as input signals.

In various embodiments, the real space service includes a delivery service, a food delivery service or (express) postal courier service. The real space service may be related or include a transport service, e.g. a delivery service. However, the real space service may also be a restaurant that intends to predict a quantity of customers.

In various embodiments, the first, second and third time period may have a period length in a range from 30 min to about 2 h. The first, second and third time period may have the same period length or different period length. The first, the second and/or the third time period may be adjustable.

In various embodiments, the third time period may be later on the same day of the first time period. As example, the food delivery demand for lunch and/or dinner may be predicted for a predetermined area based on transport data in the morning of the same working day or bank holiday.

In various embodiments, the first time period and the second time period may be on different days. As example, a food delivery demand may about the same on a first day may be about the same as of a second day, that is before the first day, in a predetermined area in case the transport demand is about the same for the first and second days.

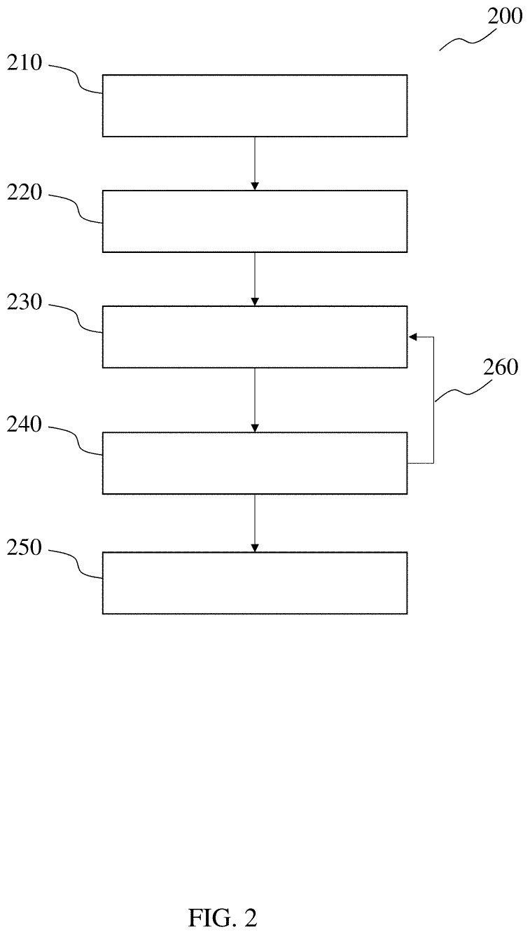

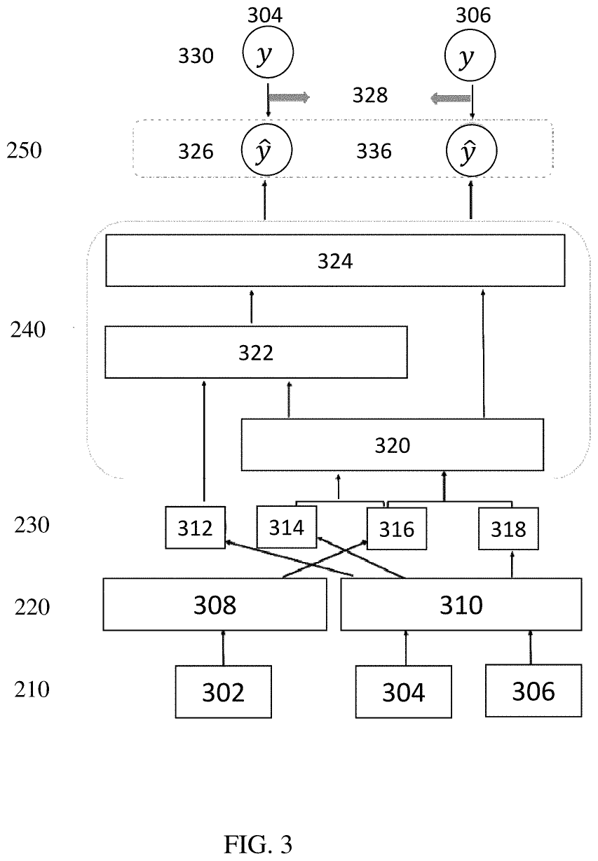

FIG. 2 and FIG. 3 illustrate logic flow diagrams of a temporally aware cross-industry learning process.

In a first process step 210, historical transport data 304 and service data 306 (of the real space service) of user 302 are input and preprocessed, e.g. raw transportation data and food delivery order data.

Then, in a further step 220, a spatio-temporal feature extraction is performed. The features include the time 312 (e.g. in hour) and the trip drop-off location (destination) 314, e.g. in geographical hash codes (also denoted as geohash code) of the food delivery and the trip drop-off location 318 of the transportation, e.g. in geographical hash codes (also denoted as geohash code).

The time 312 may be in hour of the day, from 0 to 23, as example.

The location feature 314, 318 may be the drop-off location of the transportation or delivery service, e.g. in 6 geographical hash character. The geographical hash character may include enough spatial information of the trip.

The time 312 and location 314, 318 of a trip may be translated into embedding weights, together with users 316, and then go through TAXI learning process. That is, the features (step 230) go through a shared embedding weights learning layer 320 which shares transportation data 314 and food delivery data 318, and through (step 240) TAXI layers 322, 324, which comprise one or more network layers to learn the relation among transportation data and food delivery data. Steps 230, 240 may be repeated a number of times (illustrated by arrow 260), to increase the confidence of the prediction. The TAXI learning process 320 may include a shared user-item 316 embedding weights learning 322.

Finally (step 250), personalized predicted food delivery service demand 326 is provided (in FIG. 3 denoted as y). Transportation demand 336 denoted with 9 in FIG. 3 may contain a signal to noise ratio that may prevent a reliable interpretation of the signal.

In this way, related cross-industry information can be easier captured by the embedding layer 240.

A dropout scheme with rate 0.2 may be used to overcome overfitting. Latent dimensions of embeddings may be selected case by case. The demand notification method may use different dimensions of embeddings for user and feature items. The embedding dimensions may correspond to the dimension in feature 312, 314, 316 and 318 (step 230) in FIG. 3.

In particular, after shared embedding weights are produced in the layer 310, the first, element-wise multiplier layer 320 may be implemented to the user 316 and location embeddings for food trips and transportation trips 314, 318 respectively.

Temporal embeddings 312 may be used for food 304 but not for transportation 306 since temporal information for food 312 may be closely related to determine personalized food demand 330 (y), while temporal embeddings for transportation may provide too much noise for time information.

Then temporal embeddings 312 and the output of the first multiplier layer 320 may go through an add (second) layer 322 for food trips.

A third layer 324 may be a dense layer with rectified linear unit (ReLU) activation having the outputs of the first layer 320 and of the second layer 322 as inputs. The prediction output 336 for transportation trips 306 and the prediction output 326 food trips 304 may be jointly trained 328 to achieve cross-domain joint learning. Adam learner may be employed with learning rate 0.001. Since for an individual user/passenger 302, he/she usually performs one time of transportation ride booking or food delivery order at a specific time and location, which may be a binary prediction. However, ReLU activation may be used with Poisson loss function instead of sigmoid activation with binary cross-entropy loss since counts in a business sense are predicted.

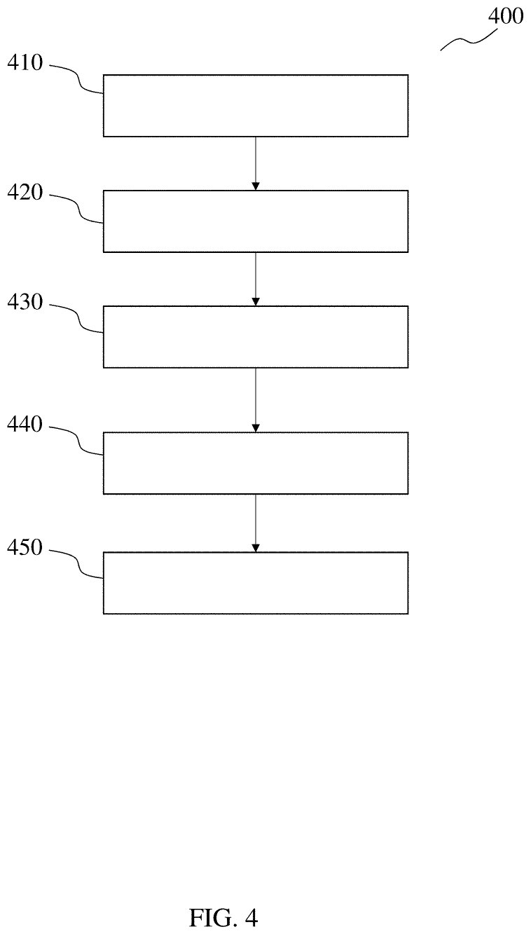

FIG. 4 illustrates a flow diagram of a demand notification method 400 according to various embodiments. The demand notification method includes determine 410 a quantity of a demand of a transport service for a plurality of users (102, 104, 106) having a predetermined area as destination in a first time period, the quantity of the demand indicating how many users of the plurality of users are determined to desire to travel into the predetermined area;; determine 420 a real space service demand from a plurality of users 102, 104, 106 to be fulfilled in the predetermined area in a second time period, wherein the real space service may be provided by a service provider 120; determine 430 a predicted real space service demand in a third time period in the predetermined area based on the quantity of users 102, 104, 106 in the predetermined area in the first time period and the demand of real space service in the predetermined area in the second time period; monitor 440 the predicted real space service demand in the third time period in the predetermined area regarding a threshold value for the predetermined area at the third time; and submit 450 a notification to the real space service provider 120 in case the predicted real space service demand may be beyond the threshold value.

### EXAMPLES

In following, examples are described that illustrate various embodiments and are not intended to limit the scope.

Example 1 is a demand notification device, including, a determining unit configured to determine a quantity of a demand of a transport service for a plurality of users (102, 104, 106) having a predetermined area as destination in a first time period, the quantity of the demand indicating how many users of the plurality of users are determined to desire to travel into the predetermined area; and wherein the determining unit is further configured to determine a real space service demand from a plurality of users to be fulfilled in the predetermined area in a second time period, wherein the real space service is provided by a service provider; an analysis unit configured to determine a predicted real space service demand in a third time period for the predetermined area based on the quantity of users in the predetermined area at the first time period and the demand of real space service in the predetermined area in the second time period and further configured to monitor the predicted real space service demand in the third time period in the predetermined area regarding a threshold value of service demand for the predetermined area at the third time; and a notification unit configured to submit a notification to the real space service provider in case the predicted real space service demand is beyond the threshold value.

In example 2, the demand notification device of example 1 further includes that the real space service includes a delivery service.

In example 3 the demand notification device of example 1 or 2 further includes that the predetermined area is a geohash code area, a postal code area or a radio cell area.

In example 4 the demand notification device of anyone of examples 1 to 3 further includes that the first, second and third time period have a period length in a range from 30 min to about 2 h.

In example 5 the demand notification device of anyone of examples 1 to 4 further includes that the first, second and third time period have the same period length.

In example 6 the demand notification device of anyone of examples 1 to 5 further includes that the first, the second and/or the third time period are adjustable.

In example 7 the demand notification device of anyone of examples 1 to 6 further includes that the determination of the predicted real space service demand is based on a recommender system using the quantity of users in the predetermined area at the first time period and the demand of real space service in the predetermined area in the second time period as input signals.

In example 8 the demand notification device of anyone of examples 1 to 7 further includes that the third time period is later on the same day of the first time period.

In example 9 the demand notification device of anyone of examples 1 to 8 further includes that the first time period and the second time period are on different days.

In example 10 the demand notification device of anyone of examples 1 to 9 further includes that the first time period is later than the second time period.

Example 11 is a computing device, including one or more processors; and a memory having instructions stored therein, the instructions, when executed by the one or more processors, cause the one or more processors to: determine a quantity of a demand of a transport service for a plurality of users (102, 104, 106) having a predetermined area as destination in a first time period, the quantity of the demand indicating how many users of the plurality of users are determined to desire to travel into the predetermined area; determine a real space service demand from a plurality of users to be fulfilled in the predetermined area in a second time period, wherein the real space service is provided by a service provider; determine a predicted real space service demand in a third time period in the predetermined area based on the quantity of users in the predetermined area at the first time period and the demand of real space service in the predetermined area in the second time period; monitor the predicted real space service demand in the third time period in the predetermined area to determine whether a threshold value of service demand for the predetermined area at the third time is reached; and submit a notification to the real space service provider in case the predicted real space service demand is beyond the threshold value.

In example 12 the computing device of example 11 further includes that the real space service includes a delivery service.

In example 13 the computing device of example 11 or 12 further includes that the predetermined area is a geohash code area, a postal code area or a radio cell area.

In example 14 the computing device of anyone of examples 11 to 13 further includes that the first, second and third time period have a period length in a range from 30 min to about 2 h.

In example 15 the computing device of anyone of examples 11 to 14 further includes that the first, second and third time period have the same period length.

In example 16 the computing device of anyone of examples 11 to 15 further includes that the first, the second and/or the third time period are adjustable.

In example 17 the computing device of anyone of examples 11 to 16 further includes that the determination of the predicted real space service demand is based on a recommender system using the quantity of users in the predetermined area at the first time period and the demand of real space service in the predetermined area in the second time period as input signals.

In example 18 the computing device of anyone of examples 11 to 17 further includes that the third time period is later on the same day of the first time period.

In example 19 the computing device of anyone of examples 11 to 18 further includes that the first time period and the second time period are on different days.

In example 20 the computing device of anyone of examples 11 to 19 further includes that the first time period is later than the second time period.

Example 21 is a demand notification method, including determine a quantity of a demand of a transport service for a plurality of users (102, 104, 106) having a predetermined area as destination in a first time period, the quantity of the demand indicating how many users of the plurality of users are determined to desire to travel into the predetermined area; determine a predicted real space service demand in a third time period in the predetermined area based on the quantity of users in the predetermined area in the first time period and the demand of real space service in the predetermined area in the second time period; monitor the predicted real space service demand in the third time period in the predetermined area regarding a threshold value for the predetermined area at the third time; and submit a notification to the real space service provider in case the predicted real space service demand is beyond the threshold value.

In example 22 the demand notification method of example 21 further includes that the real space service includes a delivery service.

In example 23 the demand notification method of example 21 or 22 further includes that the predetermined area is a geohash code area, a postal code area or a radio cell area.

In example 24 the demand notification method of anyone of examples 21 to 23 further includes that the first, second and third time period have a period length in a range from 30 min to about 2 h.

In example 25 the demand notification method of anyone of examples 21 to 24 further includes that the first, second and third time period have the same period length.

In example 26 the demand notification method of anyone of examples 21 to 25 further includes that the first, the second and/or the third time period are adjustable.

In example 27 the demand notification method of anyone of examples 21 to 26 further includes that the determination of the predicted real space service demand is based on a recommender system using the quantity of users in the predetermined area at the first time period and the demand of real space service in the predetermined area in the second time period as input signals.

In example 28 the demand notification method of anyone of examples 21 to 27 further includes that the third time period is later on the same day of the first time period.

In example 29 the demand notification method of anyone of examples 21 to 28 further includes that the first time period and the second time period are on different days.

In example 30 the demand notification method of anyone of examples 21 to 29 further includes that the first time period is later than the second time period.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A demand notification device comprising, a determining unit configured to determine a quantity of a demand of a transport service for a plurality of users having a predetermined area as destination in a first time period, the quantity of the demand indicating how many users of the plurality of users are determined to desire to travel into the predetermined area; and
wherein the determining unit is further configured to determine a real space service demand from the plurality of users to be fulfilled in the predetermined area in a second time period, wherein the real space service is provided by a service provider and wherein the real space service comprises a delivery service;
an analysis unit configured to determine a predicted real space service demand in a third time period for the predetermined area based on the quantity of users in the predetermined area at the first time period and the demand of real space service in the predetermined area in the second time period and further configured to monitor the predicted real space service demand in the third time period in the predetermined area regarding a threshold value of service demand for the predetermined area at the third time; and
a notification unit configured to submit a notification to the real space service provider in case the predicted real space service demand is beyond the threshold value.

2. The demand notification device of claim 1,
wherein the predetermined area is a geohash code area, a postal code area or a radio cell area.

3. The demand notification device of claim 1,
wherein the first, second and third time period have a period length in a range from 30 min to about 2 h.

4. The demand notification device of claim 1,
wherein the first, second and third time period have the same period length.

5. The demand notification device of claim 1,
wherein the first, the second and/or the third time period are adjustable.

6. The demand notification device of claim 1,
wherein the determination of the predicted real space service demand is based on a recommender system using the quantity of users in the predetermined area at the first time period and the demand of real space service in the predetermined area in the second time period as input signals.

7. The demand notification device of claim 1,
wherein the third time period is later on the same day of the first time period.

8. The demand notification device of claim 1,
wherein the first time period and the second time period are on different days.

9. The demand notification device of claim 1,
wherein the first time period is later than the second time period.

10. A computing device, comprising:
one or more processors; and
a memory having instructions stored therein, the instructions, when executed by the one or more processors, cause the one or more processors to:
determine a quantity of a plurality of users in a predetermined area in a first time period based on personalized destinations of the plurality of users using a transport service, wherein each of the personalized destinations is located within the predetermined area;
determine a real space service demand from the plurality of users to be fulfilled in the predetermined area in a second time period, wherein the real space service is provided by a service provider, wherein the real space service comprises a delivery service;
determine a quantity of a demand of a transport service for the plurality of users having the predetermined area as destination in the first time period, the quantity of the demand indicating how many users of the plurality of users are determined to desire to travel into the predetermined area;
monitor the predicted real space service demand in a third time period in the predetermined area to determine whether a threshold value of service demand for the predetermined area at the third time is reached; and
submit a notification to the real space service provider in case the predicted real space service demand is beyond the threshold value and/or flag the predetermined area for the third time period in the memory.

11. The computing deviceof claim 10,
wherein the first, second and third time period have the same period length.

12. The computing device of claim 10,
wherein the first, the second and/or the third time period are adjustable.

13. The computing device of claim 10,
wherein the determination of the predicted real space service demand is based on a recommender system using the quantity of users in the predetermined area at the first time period and the demand of real space service in the predetermined area in the second time period as input signals.

14. A demand notification method comprising:
determine a quantity of a demand of a transport service for a plurality of users having a predetermined area as destination in a first time period, the quantity of the demand indicating how many users of the plurality of users are determined to desire to travel into the predetermined area;
wherein each of the personalized destinations is located within the predetermined area;
determine a real space service demand from the plurality of users to be fulfilled in the predetermined area in a second time period, wherein the real space service is provided by a service provider and wherein the real space service comprises a delivery service;
determine a predicted real space service demand in a third time period in the predetermined area based on the quantity of users in the predetermined area in the first time period and the demand of real space service in the predetermined area in the second time period;
monitor the predicted real space service demand in the third time period in the predetermined area regarding a threshold value for the predetermined area at the third time; and
submit a notification to the real space service provider in case the predicted real space service demand is beyond the threshold value.
